(19) United States
(12) Patent Application Publication
(10) Pub. No.: US 2025/0084633 A1
(43) Pub. Date: Mar. 13, 2025

(54) EXPANDABLE HOUSING STRUCTURE WITH STACKING WALLS

(71) Applicant: A&C FUTURE, INC., Newport Beach, CA (US)

(72) Inventors: Qiyin Pan, Irvine, CA (US); Jiuqi Wang, Santa Ana, CA (US); Shoue Chen, Irvine, CA (US); Han Qin, Newport Beach, CA (US); Jiayang Qin, Newport Beach, CA (US)

(21) Appl. No.: 18/463,884

(22) Filed: Sep. 8, 2023

(51) Int. Cl. E04B 1/343

(52) U.S. Cl. CPC E04B 1/34305; E04B 1/34384

(57) ABSTRACT

An expandable structure includes an expansion section having walls that can stack into and be deployed from a wall enclosure central housing. Linear actuators can be deployed on the wall enclosure for facilitating the movement of wall panels into and out of the central housing. Each linear actuators can be easily dissembled out of the structure for maintenance or future upgrade. Concurrently, the linear actuators can work in synergy with a precision track system, ensuring the precise displacement of each individual wall panel. This innovative configuration not only enables efficient and accurate storage of each wall panel within the central enclosure but also concurrently serves as the foundational support structure for the cabin.

### BACKGROUND OF THE INVENTION

### 1. Field of the Invention

Embodiments of the invention relate generally to expandable structures. More particularly, embodiments of the invention relate to an expandable house structure that includes an expansion section walls that are stored as stacked multiple wall panels.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Recently, the expandable house structure is attracting more attention both in the fields of mobile homes and recreational vehicles (RVs). The expansion mode will determine the effective living area, complexity of the driving and control system, and cost for purchase and maintenance. Exploring a concise and reliable expansion mechanism is of great importance.

Traditional (RV) configurations have been characterized by a notably restricted slide-out area. The prevailing approach for RV manufacturers seeking to augment this limited space within the slide-out structure has been to enlarge the dimensions of the initial vehicle cabin. This, in turn, establishes a proportional relationship between the extent of the slide-out area and the available cabin space. However, such a solution comes with inherent limitations.

In view of the foregoing, there is a need for an expandable house structure that can expand living space with a refined slide-out configuration.

### SUMMARY OF THE INVENTION

Embodiments of the present invention aim to solve the aforementioned problems in conventional expandable structures by refining the slide-out mechanism, thereby facilitating a more efficient utilization of space. This innovative design not only enhances the functionality of the slide-out feature but also offers a more expansive and accommodating environment for the end-user, marking a promising advancement in RV design.

Embodiments of the present invention provide an expandable structure comprising a main structure; a first expansion section, the first expansion section expandable outward in a first direction from the main structure; and walls of the first expansion section are formed from a plurality of wall panels, the wall panels, in a retracted configuration, are storable in a stacked arrangement.

Embodiments of the present invention provide an expandable structure comprising a main structure; a first expansion section, the first expansion section expandable outward in a first direction from the main structure; and a second expansion section expandable outward in a second direction from the main structure, wherein first and second side walls of the first expansion section are formed from a plurality of first and second side wall panels, the wall panels, in a retracted configuration, are storable in a stacked arrangement; third and fourth side walls of the second expansion section are formed from a plurality of second expansion section third and fourth side wall panels that, in a retracted configuration, are storable in a stacked arrangement; first and second wall enclosure housings holding the plurality of first and second wall panels, respectively, in the retracted configuration; and third and fourth wall enclosure housings holding the plurality of second expansion section third and fourth wall panels, respectively, in the retracted configuration.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of an expandable structure, in a retracted state, according to an exemplary embodiment of the present invention;

FIG. 2 illustrates a perspective view of the expandable structure of FIG. 1, in an expanded state;

FIG. 3 illustrates a floor-plan view of the expandable structure of FIG. 2;

FIG. 4 illustrates a perspective view of a wall enclosure housing for providing an expandable wall for the expandable structure of FIG. 1;

FIG. 5 illustrates an exploded view of an actuator used in the wall enclosure housing of FIG. 4;

FIG. 6 illustrates an exploded view of the wall enclosure housing of FIG. 4;

FIG. 7A illustrates a cross-sectional view of the wall enclosure housing of FIG. 4, with one wall panel therein;

FIG. 7B illustrates a detailed cross-sectional view, taken along circle 74 of FIG. 7A;

FIGS. 8A through 8D illustrate actuation of an actuator of the wall enclosure housing to move a wall panel from a stored position to a deployed position;

FIG. 9A illustrates a side view of the wall enclosure housing of FIG. 4;

FIG. 9B illustrates a cross-sectional view taken along line 9-9 of FIG. 9A, with three wall panels in the wall enclosure housing in a stored position;

FIG. 10A illustrates a side view of the wall enclosure housing of FIG. 4;

FIG. 10B illustrates a cross-sectional view taken along line 10-10 of FIG. 10A, with the three wall panels moved into a first wall panel deployment position;

FIG. 11A illustrates a side view of the wall enclosure housing of FIG. 4;

FIG. 11B illustrates a cross-sectional view taken along line 11-11 of FIG. 11A, with the first wall panel being moved out of the wall enclosure housing and the second wall panel being moved to interlock with the first wall panel;

FIG. 12A illustrates a side view of the wall enclosure housing of FIG. 4;

FIG. 12B illustrates a cross-sectional view taken along line 12-12 of FIG. 12A, with the second wall panel moved to a deployment position after interlocking with the first wall panel;

FIG. 13A illustrates a side view of the wall enclosure housing of FIG. 4;

FIG. 13B illustrates a cross-sectional view taken along line 13-13 of FIG. 13A, with the second wall panel being moved out of the wall enclosure housing, while the third wall panel interlocks with the second wall panel;

FIG. 14A illustrates a first step in retraction of a wall of an expansion section, where the third wall panel is moved into the wall enclosure housing;

FIG. 14B illustrates another step in retraction of a wall of an expansion section, where the third wall panel is moved toward a stored position, removing the interlock with the second wall panel;

FIG. 14C illustrates another step in retraction of a wall of an expansion section, where the actuator that pushed the third wall panel toward the stored position is retracted;

FIG. 14D illustrates another step in retraction of a wall of an expansion section, where the second wall panel is moved inside of the wall enclosure housing;

FIG. 14E illustrates another step in retraction of a wall of an expansion section, where the second wall panel is pushed toward the stored position by an actuator;

FIG. 15 illustrates a perspective view of a track operable to move the wall panels in and out of the wall enclosure housing;

FIG. 16 illustrates a perspective view of another track operable to move the wall panels in and out of the wall enclosure housing;

FIG. 17 illustrates an exploded view of the track of FIG. 15, with a plurality of track adapters; and

FIGS. 18A through 18D illustrate top, perspective, front and side views of the track adapter shown in FIG. 17.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide an expandable structure that includes an expansion section having walls that can stack into and be deployed from a wall enclosure central housing. Linear actuators can be deployed on the wall enclosure for facilitating the movement of wall panels into and out of the central housing. Each linear actuators can be easily dissembled out of the structure for maintenance or future upgrade. Concurrently, the linear actuators can work in synergy with a precision track system, ensuring the precise displacement of each individual wall panel. This innovative configuration not only enables efficient and accurate storage of each wall panel within the central enclosure but also concurrently serves as the foundational support structure for the cabin.

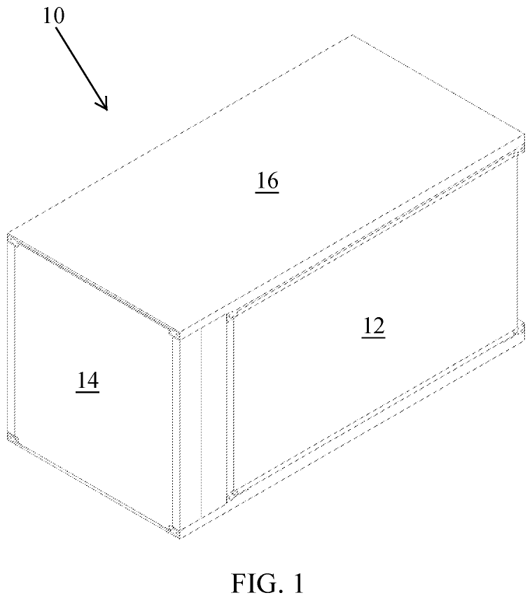

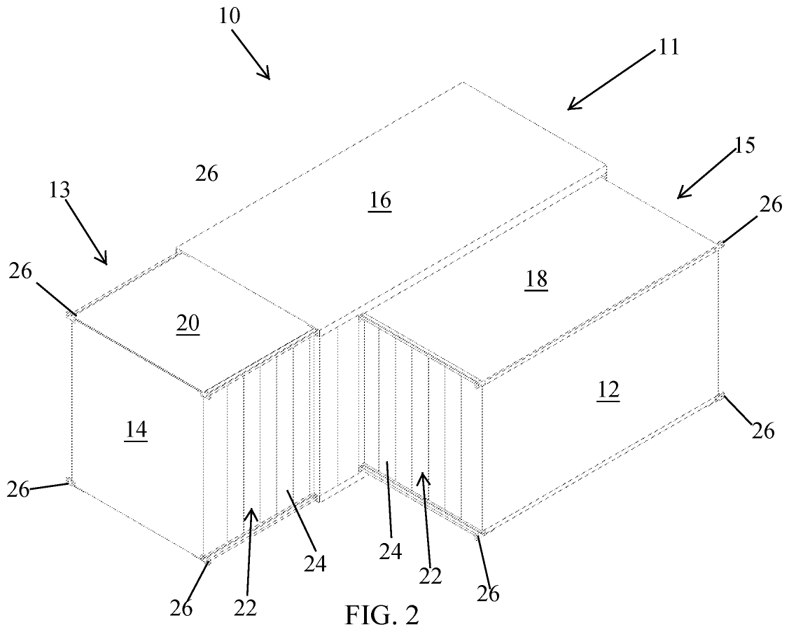

Referring to FIGS. 1 and 2, an expandable structure 10 can be transformed between an retracted state (FIG. 1), which may be suitable for transport on a highway or transport as part of a recreational vehicle, for example, and an expanded state (FIG. 2), where one or more expansion sections can extend from one or more sides of the expandable structure 10.

The expandable structure 10 can include a main structure 11 and one or more expansion sections, such as side expansion section 15 and rearward expansion section 13. A roof 16 may cover the main structure and movable outer walls, such as rear wall 14 and side wall 12, can be movable outward to provide an outer wall of the expansion section 13, 15, respectively. Once expanded, the structure 10 can include an expansion section roof, such as rearward expansion section roof 20 and side expansion section roof 18. Expansion section side walls 22 of each expansion section can extend from the outer walls 12, 14 and the main structure 11. Tracks 26 may be provided on each side of each expansion section 13, 15 for moving the expansion section side walls 22 outward from the main structure 11. The tracks 26 may be located on both the top and bottom at each side of each expansion section. Thus, in some embodiments, each expansion section 13, 15 can include a set of four tracks along which the expansion section side walls 22 move, along with the outer walls 12, 14.

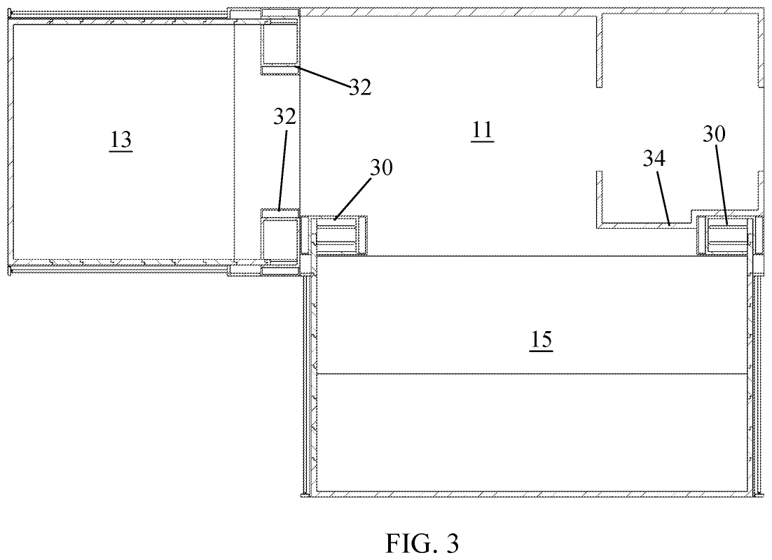

The expansion section side walls 22 can be formed from a plurality of wall panels 24, interlocked together as described in greater detail below. The wall panels 24 may be stored in wall enclosure housings 30, 32. As shown in FIG. 3, two side expansion wall enclosure housings 30 may be disposed, within the main structure 11, on each side where the side expansion section 15 will extend. Similarly, two rearward expansion wall enclosure housings 32 may be disposed, within the main structure 11, on each side where the rearward expansion section 13 will extend. Unlike conventional slide out structures with rigid walls that extend into the main structure, with the wall panel expansion wall structure, the wall panels can be stored in a small housing that can also serve as structural support for the main structure 11. Thus, as shown in FIG. 3, expansion sections can be disposed out of adjacent rear and side walls of the main structure, something not possible with conventional rigid walled slide outs. Further, an interior wall 34 may be disposed within the main structure 11, adjacent where the side wall of the expansion section will extend, which also is not possible with conventional rigid walled slide outs.

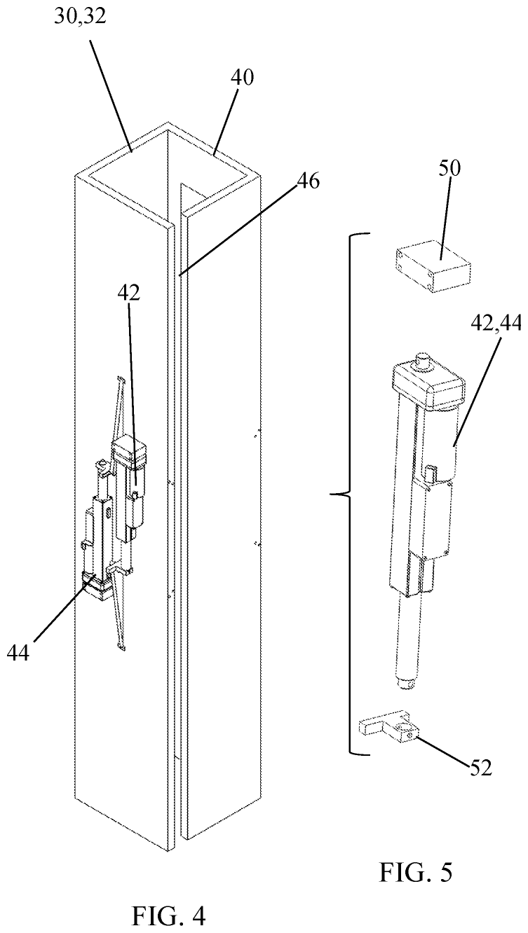

Referring to FIG. 4, the wall enclosure housings 30, 32 can include a main housing 40 with actuators 42, 44 disposed on each side thereof. A slot 46 can be provided along an entire longitudinal direction to permit entry and exit of the wall panels 24 therethrough. In the embodiment shown in FIG. 4, four linear actuators can be affixed to each of the wall enclosure housings 30, 32. Positioned on each side are paired linear actuators responsible for facilitating the movement of wall panels into and out of the housing. Each linear actuators can be easily dissembled out of the structure for maintenance or future upgrade. Concurrently, these four linear actuators can work in synergy with a precision track system, ensuring the precise displacement of each individual wall panel. This configuration not only enables efficient and accurate storage of each wall panel within the wall enclosure housings 30, 32 but also concurrently serves as the foundational support structure for the main structure 11.

Referring to FIG. 5, the actuator 42, 44 may be a linear actuator having a mounting plate 50 and actuator and push board connector 52, as described in greater detail below.

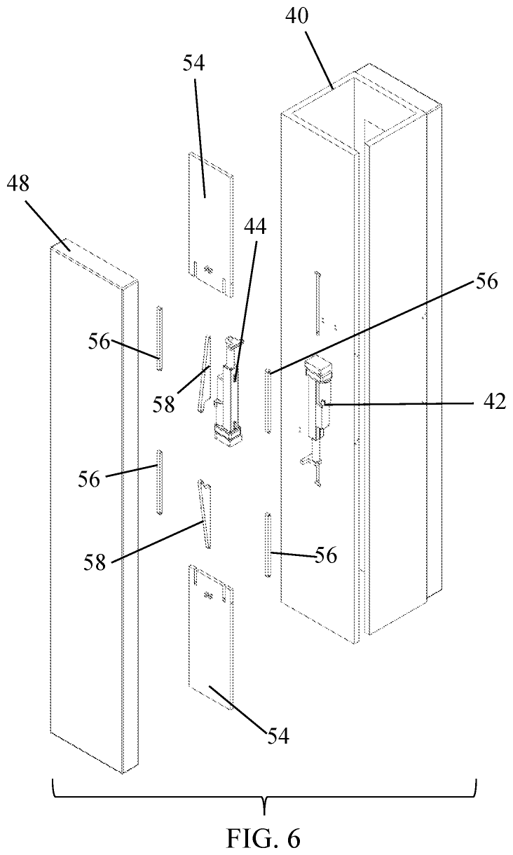

Referring to FIG. 6, a detailed view of an exemplary actuator assembly on the wall enclosure housing 40 is shown, where the actuators 42, 44 can attach to pushing boards 54 via auxiliary push arms 56 and a main push arm 58. One of the actuators can move an upper one of the push arms 54 and the other actuator can move a lower one of the push arms 54. An actuator mechanism cover 48 may provide an external cover over the actuators and provide a finished appearance for the wall enclosure housings 30, 32.

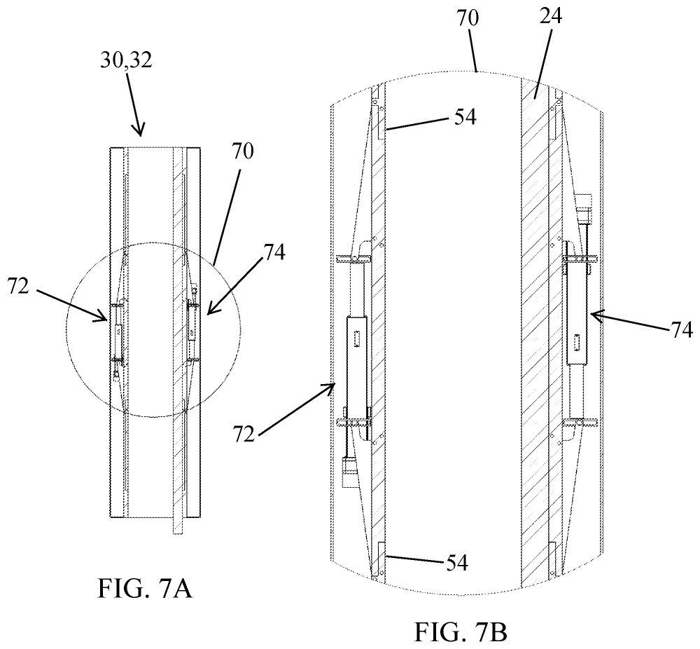

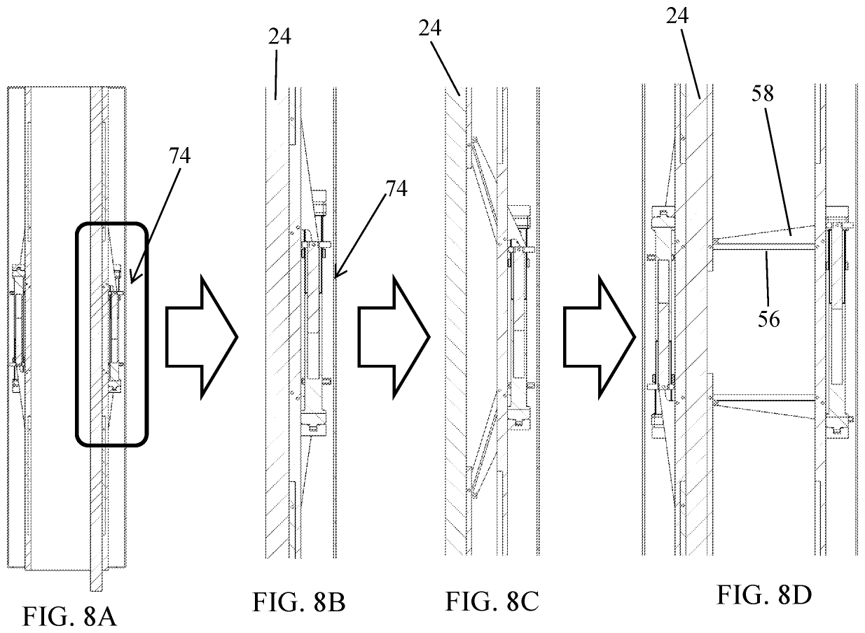

Referring to FIGS. 7A and 7B, element 72 refers to a set of actuators providing pushing of the wall panels 24 into a stored position (also referred to as storing actuator 72 or retraction actuator module 72), while element 74 refers to a set of actuators providing pushing of the wall panels 24 into a deployment position (also referred to as deployment actuator 74 or extension actuator module). FIGS. 8A through 8D illustrate actuation of the deployment actuator 74 to move a wall panel 24 from the stored position to the deployment position.

The retraction actuator module 72 is positioned on the left side of the wall housing, while its complementary component, the extension actuator module 74, is situated on the opposing side. When effecting the extension of the wall panel 24, the extension module 74 seamlessly interfaces with the mobile track system, orchestrating the outward movement of the panel to optimize space utilization.

In contrast, during the retraction phase, a collaborative effort between the retraction and extension modules 72, 74 comes into play. This concerted operation facilitates a gradual and precisely controlled withdrawal of the wall panel 24 from the mobile track, as described in greater detail below, ensuring impeccable alignment and providing interim stabilization until the wall panel 24 is fully retracted within the wall enclosure housing 30, 32.

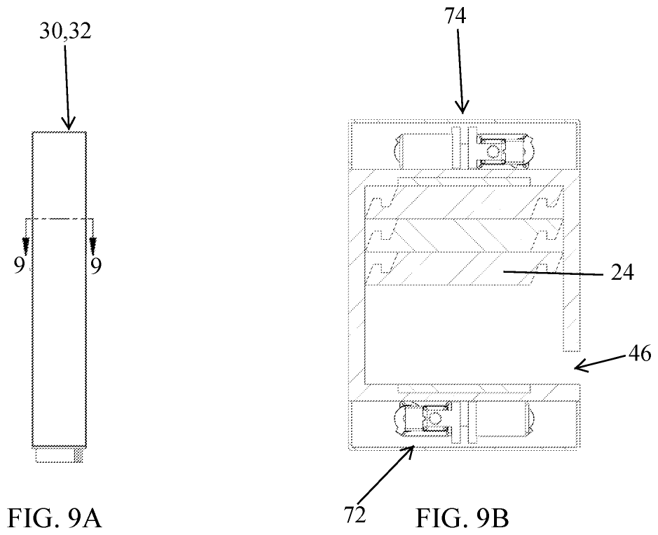

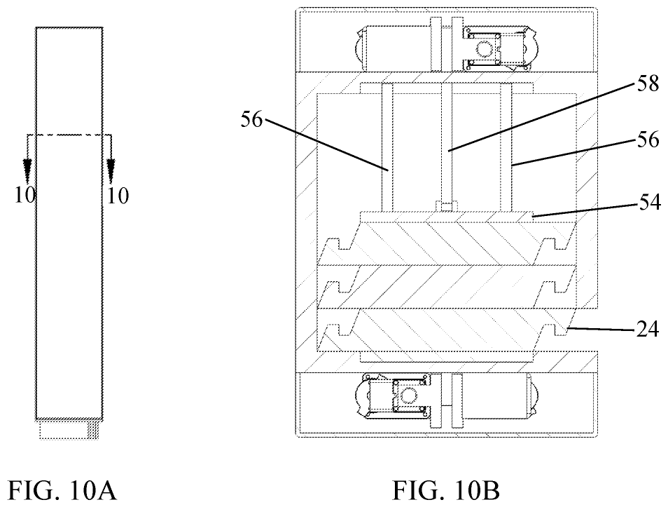

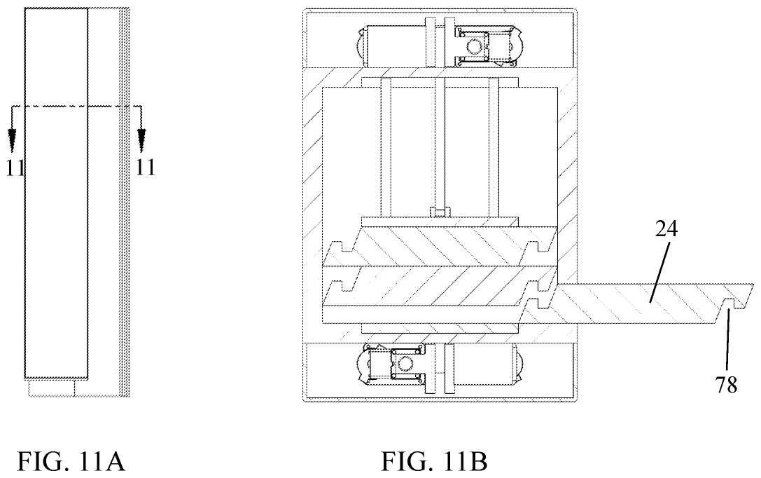

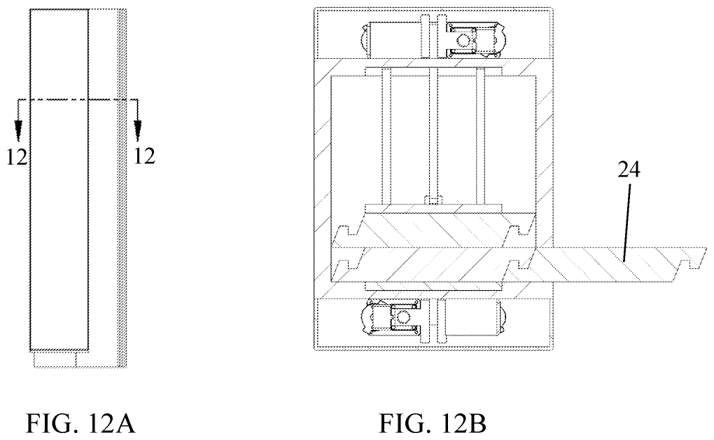

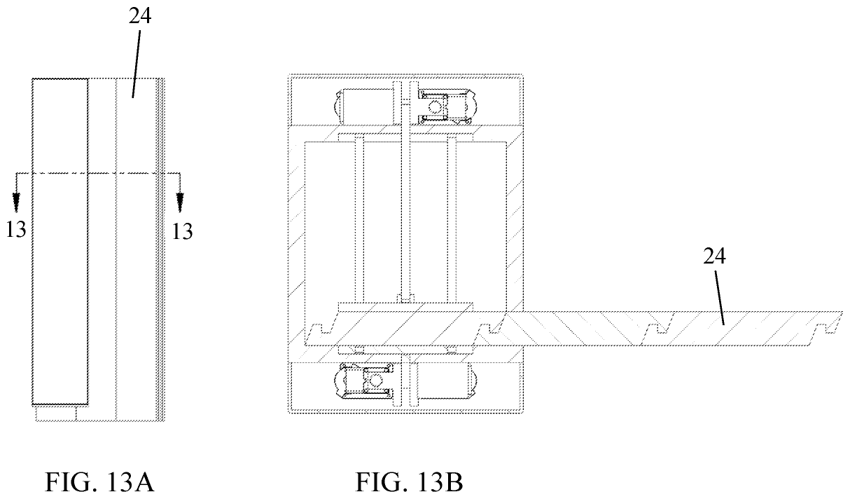

Referring now to FIGS. 9A through 13B, an exemplary expansion process is illustrated with three wall panels 24 shown for illustrative purposes. The number of wall panels 24 can, of course, vary depending on the side of the expansion side wall. In FIG. 9B three wall panels are in the wall enclosure housing in a stored position. They are moved into a first wall panel deployment position in FIG. 10B, and, in FIG. 11B, the first wall panel is moved out of the wall enclosure housing and the second wall panel being moved to interlock at interconnect 78 with the first wall panel. In FIG. 12B, the second wall panel is moved to a deployment position after interlocking with the first wall panel. Various interlocking shapes may be provided between the sides of adjacent wall panels 24. In FIG. 13B, the second wall panel is moved out of the wall enclosure housing, while the third wall panel interlocks with the second wall panel. Finally, the third wall panel may be deployed outward to complete the expansion of the wall panels 24 out of the wall enclosure housing 30, 32.

As can be seen in FIG. 11A, pins 76 may be provided at the bottom of the wall panel 24. Similar pins may be provided at the top of the wall panel 24. These pins 76 can engage with the wall panel and track adapters, as described below. These wall panel and track adapters may be positioned in a track that can move to extend the wall panels 24 out of (or move the wall panels 24 into) the wall enclosure housing 30, 32. While only shown in FIG. 11A, such pins 76 may be on each wall panel 24. Typically, at least two pins 76 are disposed on each end of each wall panel 24.

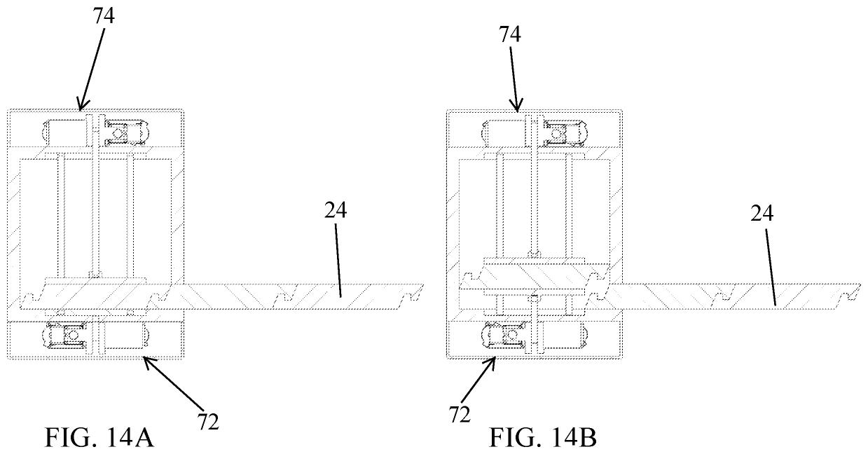

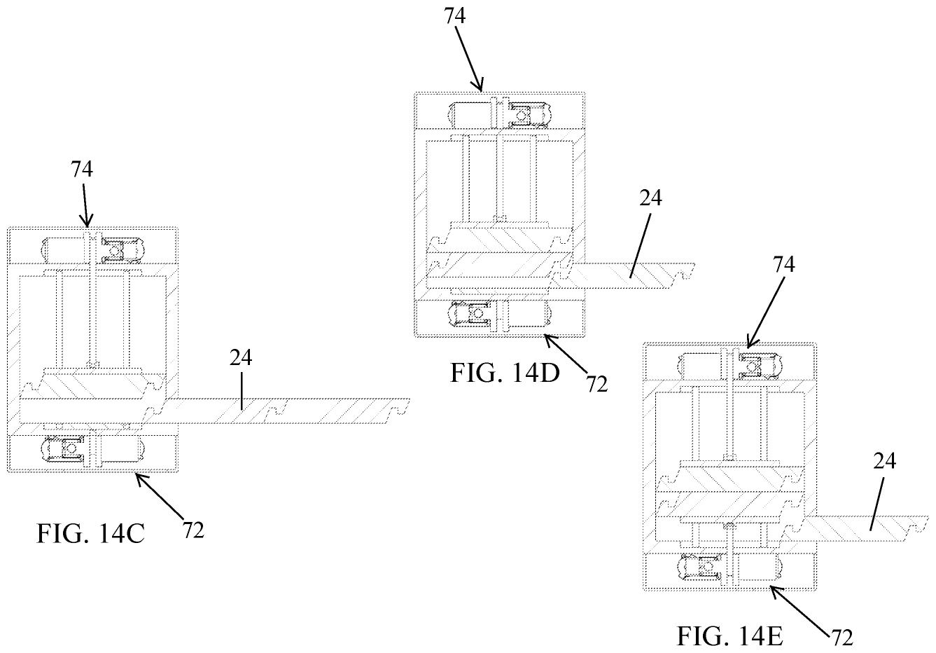

Referring to FIGS. 14A through 14E, the retraction of a wall of an expansion section is shown, where FIG. 14A shows how the third wall panel is moved into the wall enclosure housing (via the tracks and the wall panel and track adapters, as discussed below). FIG. 14B illustrates another step in retraction of a wall of an expansion section, where the third wall panel is moved toward a stored position, removing the interlock with the second wall panel. FIG. 14C illustrates another step in retraction of a wall of an expansion section, where the actuator that pushed the third wall panel toward the stored position is retracted. FIG. 14D illustrates another step in retraction of a wall of an expansion section, where the second wall panel is moved inside of the wall enclosure housing, and FIG. 14E illustrates another step in retraction of a wall of an expansion section, where the second wall panel is pushed toward the stored position by an actuator.

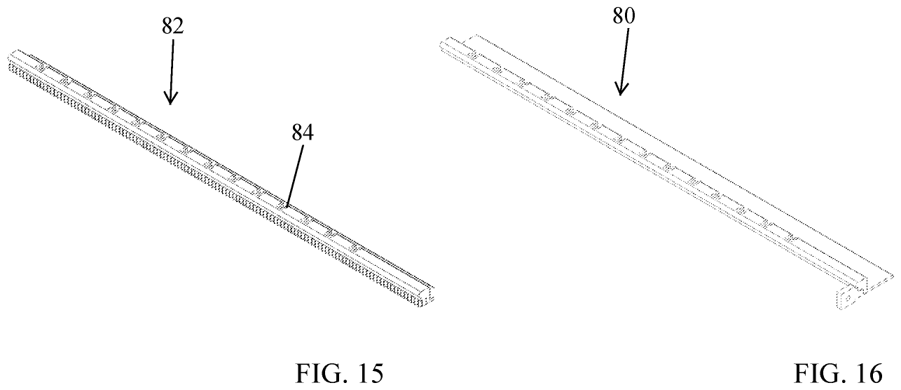

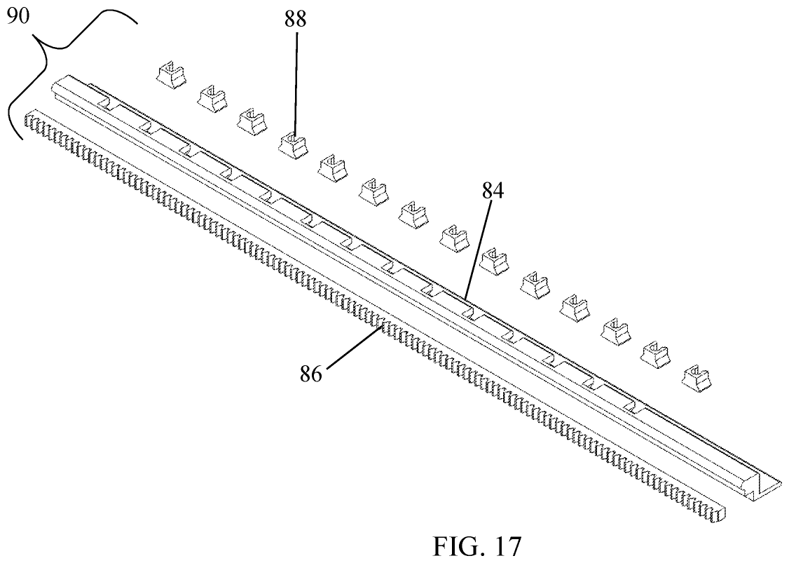

Referring to FIGS. 15 and 17, a rack track 82 can include a rack 86 attached to a main track 84. A rack assembly 90 can include wall panel and track adapters 88 disposed along the main track 84. The rack track 82 can provide a surface for driving the rack assembly 90 outward from the main structure 11 when expanding or retracting the one or more expansion sections, such as expansion sections 13, 15. In an alternate embodiment, a hydraulic track assembly 80 may be used, as shown in FIG. 16, where, similar to that shown in FIG. 17, wall panel and track adapters 88 may be disposed therealong for removably connecting the wall panels 24 to the track assembly 80, 90.

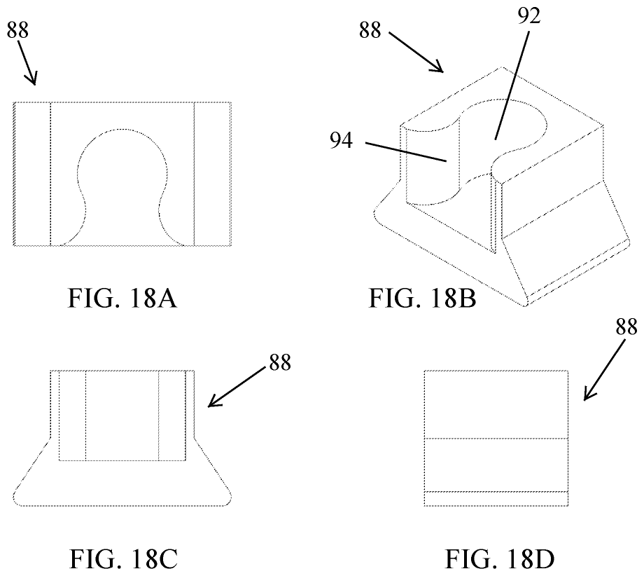

Referring to FIGS. 18A through 18D, the wall panel and track adapters 88 are shown, where an inner receiving region 92 can receive the pins 76 (see FIG. 11B) from the wall panels. Side portions 94 may provide a narrowed entry path into the inner receiving region 92. Such a configuration may securely engage the pins 76 of the wall panels for extension and retraction thereof.

This innovative design harmoniously merges the rack and panel wall tracks, culminating in the need for a motorized mechanism to orchestrate the synchronized movement of both the track system and the designated slide-out area. Delving into the specifics, each distinct slide-out segment (such as expansion section 13 and expansion section 15) can rely upon a quartet of tracks, and in tandem, these tracks can be propelled into action by four dedicated motors. This configuration promises enhanced precision and efficiency in the extension and retraction process of the slide-out feature.

The wall panel and track adaptors 88 can be affixed onto the track, and in correspondence with each wall panel, two positioning pins 76 can be situated both at the upper and lower ends of the wall panels 24, as described above. As the expansion procedure takes place, these positioning pins are inserted into the adaptors 88, effectively fastening the wall panel securely. The overarching objective of this design is to ensure a user-friendly operation while concurrently establishing a robust and dependable framework for the multiple panel expansion side wall structure.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. An expandable structure comprising:
a main structure;
a first expansion section, the first expansion section expandable outward in a first direction from the main structure; and
walls of the first expansion section are formed from a plurality of wall panels, the wall panels, in a retracted configuration, are storable in a stacked arrangement.

2. The expandable structure of claim 1, wherein the plurality of wall panels, when stacked in the retracted configuration, have planar interior or exterior faces of each wall panel adjacent each other.

3. The expandable structure of claim 1, further comprising a second expansion section expandable outward in a second direction from the main structure, wherein second expansion section walls are formed from a plurality of second expansion section wall panels that, in a retracted configuration, are storable in a stacked arrangement.

4. The expandable structure of claim 1, wherein the plurality of wall panels, in the retracted configuration, are stored in a wall enclosure housing, the wall enclosure housing having a slot formed therein for passing each of the plurality of wall panels into and out of the wall enclosure housing.

5. The expandable structure of claim 4, wherein a first wall enclosure housing is used for a first expansion section side wall of the expansion section, and a second wall enclosure housing is used for a second expansion section side wall of the expansion section.

6. The expandable structure of claim 5, wherein the first and second wall enclosure housings provide structural support for the main structure.

7. The expandable structure of claim 5, further comprising:
a first track is extendable outward from the main structure on a first side of the expansion section; and
a second track is extendable outward from the main structure on a second side of the expansion section, wherein:
the first track engages with a first side deployed one of the plurality of wall panels of the first expansion section side wall as the first side deployed one is moved into a first side deployment position; and
the second track engages with a second side deployed one of the plurality of wall panels of the second expansion section side wall as the second side deployed one is moved into a second side deployment position.

8. The expandable structure of claim 7, wherein:
the first track includes an upper first track and a lower first track, engaging with upper and lower portions, respectively, of each of the plurality of wall panels of the first expansion section side wall; and
the second track includes an upper second track and a lower second track, engaging with upper and lower portions, respectively, of each of the plurality of wall panels of the second expansion section side wall.

9. The expandable structure of claim 7, further comprising a plurality of wall panel and track adapters disposed along the first track and the second track, wherein each of the first and second side deployed ones of the plurality of wall panels include a pin that engages with the wall panel and track adapter as the wall panel is moved into the deployment position.

10. The expandable structure of claim 7, further comprising actuators provided on opposite sides of the wall enclosure housing, the actuators moving wall panels disposed therein between the deployment position and a storage position.

11. The expandable structure of claim 10, wherein the actuators include a pair of actuators on opposing sides of the wall enclosure housing.

12. The expandable structure of claim 7, wherein, once the first and second deployed ones of the plurality of wall panels are moved out of a slot formed in respective first and second wall enclosure housings by engagement with and movement of the first and second tracks, an additional one of the plurality of wall panels is moved into the deployment position in each of the first and second wall enclosure housings.

13. The expandable structure of claim 12, wherein a side of the first and second deployed ones interconnect with a side of the additional one in each of the first and second wall enclosures as the additional one is moved into the deployment position.

14. An expandable structure comprising:
a main structure;
a first expansion section, the first expansion section expandable outward in a first direction from the main structure; and
a second expansion section expandable outward in a second direction from the main structure, wherein:
first and second side walls of the first expansion section are formed from a plurality of first and second side wall panels, the wall panels, in a retracted configuration, are storable in a stacked arrangement;
third and fourth side walls of the second expansion section are formed from a plurality of second expansion section third and fourth side wall panels that, in a retracted configuration, are storable in a stacked arrangement;
first and second wall enclosure housings holding the plurality of first and second wall panels, respectively, in the retracted configuration; and
third and fourth wall enclosure housings holding the plurality of second expansion section third and fourth wall panels, respectively, in the retracted configuration.

15. The expandable structure of claim 14, further comprising:
a first track is extendable outward from the main structure on a first side of the first expansion section;
a second track is extendable outward from the main structure on a second side of the first expansion section;
a third track is extendable outward from the main structure on a first side of the second expansion section;
a forth track is extendable outward from the main structure on a second side of the second expansion section, wherein:
the first and second tracks engaging with the first and second wall panels when in a deployment position within the first and second wall enclosure housings;
the first and second tracks moving the engaged first and second wall panels out of the first and second wall enclosure housings through slits formed therein during expansion of the first expansion section;
the third and fourth tracks engaging with the third and fourth second expansion section wall panels when in a deployment position within the third and fourth wall enclosure housings; and
the third and fourth tracks moving the engaged third and fourth second expansion section wall panels out of the third and fourth wall enclosure housings through slits formed therein during expansion of the second expansion section.

16. The expandable structure of claim 15, wherein:
the first and second tracks includes upper first and second tracks and lower first and second tracks, each engaging with upper and lower portions, respectively, of each of the first and second wall panels when moved into the deployment position; and
the third and fourth tracks includes upper third and fourth tracks and lower third and fourth tracks, each engaging with upper and lower portions, respectively, of each the third and fourth wall panels when moved into the deployment position.

17. The expandable structure of claim 15, further comprising a plurality of wall panel and track adapters disposed along the first, second, third and fourth tracks, wherein each of the first, second, third and fourth wall panels include a pin that engages with the wall panel and track adapter as the first, second, third and fourth wall panels are moved into the deployment position.

18. The expandable structure of claim 14, further comprising actuators provided on opposite sides of the first and second wall enclosure housing, the actuators moving wall panels disposed therein between the deployment position and a storage position.

19. The expandable structure of claim 14, wherein, once first one of the plurality of the first and second side wall panels are moved out of respective first and second wall enclosure housings, additional ones of the plurality of the first and second side wall panels are moved out of respective first and second wall enclosure housings, adjacent respective first ones.

20. The expandable structure of claim 19, wherein a side of the first ones interconnect with a side of the additional ones as the additional ones are moved into the deployment position.
